(19) United States
(12) Patent Application Publication
(10) Pub. No.: US 2011/0060692 A1
(43) Pub. Date: Mar. 10, 2011

(54) Martin Grassroots Operational Structure (MGOS) Method

(76) Inventor: Nathan James Martin, Shelby, OH (US)

(21) Appl. No.: 12/555,078

(22) Filed: Sep. 8, 2009

(51) Int. Cl. G06Q 10/00; G06Q 50/00

(52) U.S. Cl. 705/301

(57) ABSTRACT

A method for organizing grassroots (individuals or collective groups of people) operations to a user's preference utilizing a comprehensive grassroots operational structure, producing operational success through greater efficiency in grassroots operations, recruitment, training, and retention within the organization. The creation and subsequent management of this structure will allow the user to recruit and place grassroots volunteers in a quick, effective, and efficient manner. The method breaks down the organized area into smaller Operational Areas, categorizes and codes those Operational Areas, sets minimal staffing levels for the structure, and fills the structure with positions which contain: 1. How does this position fit into the organization's purpose; 2. What training is needed for this position; 3. Which other position does this position report to; 4. If applicable, the other positions that report to this position; and 5. The Position's Title. The entire structure is managed through reporting, recruiting, and volunteer placement until the completion of the grassroots operation. The method produces operational success through greater efficiency in grassroots operations. The method also produce better outcomes for corporations or other organizations who wish to meet consumers in an organized personal way cheaper than a traditional advertising campaign. The method drastically improves the efficiency of recruitment, training, and retention in organizations.

### CROSS-REFERENCE TO RELATED APPLICATIONS

Not Applicable

### STATEMENT REGARDING FEDERALLY SPONSORED RESEARCH AND DEVELOPMENT

This invention was not made as part of a federally sponsored research or development project.

### REFERENCE TO SEQUENCE LISTING A TABLE OR A COMPUTER PROGRAM LISTING COMPACT DISC APPENDIX

Not Applicable

### TECHNICAL FIELD

The present application relates to the organization of individuals or collective groups of people (commonly referred to as the grassroots) in the political or corporate areas.

### BACKGROUND OF THE INVENTION

Those in the field of grassroots organization in both political and corporate areas recognize the benefits of having a properly organized grassroots operation. However, currently users do not possess an effective and efficient way of organizing their grassroots operations. Current methods do not allow upper echelons to effectively know who they need to recruit as volunteers and how to place them within the organization. The current methods to not rely on knowledge of what is needed to know where vacancies are, as a result, volunteers are not plugged into the Grassroots organization in a timely and effective manner and valuable man-hours are lost. In addition, man-hours can be wasted in areas not needed to achieve the goal of the grassroots operation. The current organizational methods are organization-centric not allowing volunteers to reach their potential.

The present invention solves this problem by providing a method of forming a comprehensive grassroots operations structure that allows for efficiency and greater effectiveness in recruiting and placement of volunteers quickly based on the actual needs of the grassroots operation.

Currently, users rely on general “cattle calls” for volunteers and loose grassroots organizing. This results in a lag of time between when a volunteer or leader applies for work for the user. The current methodology does not give users sufficient ability to manage their grassroots structures in a way that is both efficient and effective. The present invention offers users a comprehensive grassroots operational structure which eliminates the lag time when a volunteer applies for work, enables smoother management of the overall operation, and makes for efficient and effective capturing of volunteer man-hours. Through this, the structure becomes volunteer-centric.

### SUMMARY OF INVENTION

In its most general configuration, the present invention advances the state of the art with a variety of new capabilities and overcomes many of the shortcomings of prior methods in new and novel ways. In its most general sense, the present invention overcomes the shortcomings and limitations of the prior art in any of a number of generally effective configurations.

In one of the many preferable configurations, the present invention is to be a method for organizing grassroots (individuals or collective groups of people) operations to a user's preference utilizing a comprehensive grassroots operational structure, producing operational success through greater efficiency in grassroots operations, recruitment, training, and retention within the organization.

In accordance with another aspect of the invention a grassroots operations plan incorporates operational values for the structure to support.

In accordance with another aspect of the invention the area of organization is broke down into Operational Areas.

In accordance with another aspect of the invention the Operational Areas are categorized according to their role in the structure: Basic, Intermediary, or Headquarters.

In accordance with another aspect of the invention the lowest category, “basic” is coded according to the favorably rating of the Operational Area.

In accordance with another aspect of the invention using the favorability rating, Minimum Staffing Levels are established for each “Basic” Operational Area.

In accordance with another aspect of the invention utilizing the Minimum Staffing Levels, positions are assigned to the “Basic” Operational Area including: 1. How does this position fit into the organization's purpose; 2. What training is needed for this position; 3. Which other position does this position report to; 4. If applicable, the other positions that report to this position; and 5. The Position's Title.

In accordance with another aspect of the invention leadership modules for the “Intermediary” and “Headquarters” Operational Areas are developed.

In accordance with another aspect of the invention the comprehensive grassroots operational structure is completed in its entirety.

In accordance with another aspect of the invention the user manages the structure using reporting, recruiting, and placement of volunteers until the grassroots operation is complete.

### BRIEF DESCRIPTION OF THE DRAWINGS

FIG. 1 is a flow chart of the preferred embodiment of the method.

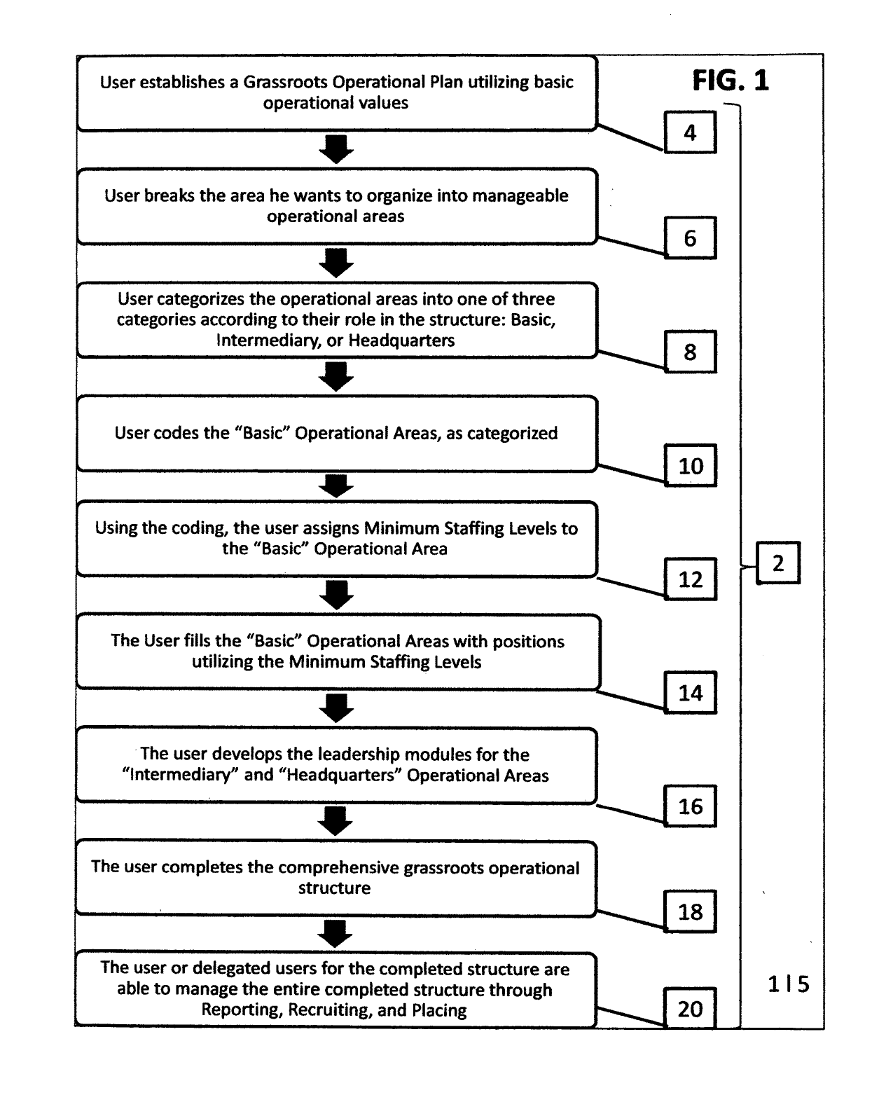

FIG. 2 is a simple example of a completed comprehensive grassroots operational structure.

FIG. 3 is a diagram example of a “Headquarters” Operational Area leadership module.

FIG. 4 is a diagram example of an “Intermediary” Operational Area leadership module.

FIG. 5 is a diagram example of a “Basic” Operational Area module.

### DETAILED DESCRIPTION OF THE PREFERRED EMBODIMENT

### Reference Number Name of Step

2 Method
4 Incorporating
6 Assessing
8 Categorizing
10 Coding
12 Assigning
14 Filling
16 Developing
18 Completing
20 Managing

The method 2 describes a method of organizing a grassroots operation based on the needs of the Operational Area and input from the user

In the step of Incorporating 4, the user of the present method (such as a grassroots consultant or organizer, but including a computer or machine) incorporates the values that allow the method to work within the framework of the organization (such as a campaign or grassroots organization, but including corporations and other groups) through the use of a “Grassroots Operations Plan” (GoP). The name(s) of this plan is simply a suggestion and a user may choose any other names or identities for this plan.

The “Grassroots Operations Plan” is a detailed plan of how a grassroots operation benefits the user and/or the user's organization. It is understood that a lot of the values are already incorporated into what the organization does. However, the GoP deals specifically with how the grassroots are able to help the user and/or the user's organization. The following items or values should be incorporated, as a rule, into the GoP: 1. Purpose (How does the grassroots perpetuate the mission of the organization?); 2. Leadership (Who manages the structure and how are their roles used to manage the grassroots operational structure?); 3. Volunteers (The backbone of the grassroots operation, how are they utilized what volunteer skills are needed?); 4. Training (Quick and thorough training is necessary for effective organization, how is this training incorporated); 5. Standards (What goals and metrics for success are in place to ensure the Grassroots Operation works to its fullest potential?); and 6. Continuity (What is the plan to continue the grassroots operation even after volunteers have left or come into the structure?). Further, this step and, consequently, the GoP is not limited these six (6) values. For example, the user may write a plan incorporating as few as three items/values, with no upper limit on items/values, but preferably no more than ten items/values.

In the step of Assessing 6, the user of the method identifies the district or area that needs to be organized and breaks it down into Operational Areas (OA). For example, the user may assess a state and break it into OAs as follows: State; District; County; City; and Precinct. The user names these OAs according to custom and needs of the Area. The names of this example are simply suggestions and a user may choose any other names or identities for these OAs.

In the step of Categorizing 8, the user of the method categorizes each OA as one of three possibilities: Basic (The building block for the comprehensive structure. The lowest leveled OA should be the Basic OA and it will have the most volunteers put into it); Intermediary (This is a HQ-lite. It is going to have a coordinator, but typically they will work as an extension of the HQ and don't have a heavy work module to run); or Headquarters (This module has a heavy leadership module. It will have more staff and training oriented positions. It will have very few volunteer positions. They also fall in line with traditional levels of leadership in other organizations. i.e. many organizations have state and county leaders; these would be an ideal place for HQ OAs.). Using the previous example from Assessing 6, the categorization could be as follows: State (HQ); District (Inter.); County (HQ); City (Inter.); and Precinct (Basic).

In the step of Coding 10, the user of the method takes each “Basic Operational Area” and identifies it as in one of three groups: Green (Over 55% of the population in this GO holds a favorable view of the purpose of the grassroots organization); Yellow (48-55% favorable); or Red (below 48% favorable). To determine the favorability of the area, the user will utilize past election tallies and, if available, current polling.

In the step of Assigning 12, the user of the method assigns Minimum Staffing Levels (MSL) to “Basic Operational Area.” Minimum Staffing Levels are based on the coding given to each Basic OA from the step of Coding 10 and the voting population of the OA. To determine the voting population of the OA, the user will utilize existing information known in the art, such as voter rolls or census data. Minimum Staffing Levels are assigned in the following way: OA is coded Green (1 volunteer for every 100 voters); OA is coded Yellow (1 volunteer for every 75 voters); OA is coded Red (1 volunteer for every 50 voters); and the minimum MSL is 5 volunteers for any given Operational Area. For example, a Basic OA has 1,000 voters and it is coded green, therefore its MSL would be 10 volunteers. As a note, Minimum Staffing Levels are just that, minimum. The user may add as many additional slots as they want, BUT preferably not more than 100% the size of the MSL. The user would also be advised that if the MSL is filled in one OA to look at neighboring OAs to fill vacancies before adding slots. This assigning will mean that OAs that are traditionally favorable will have less staff, this is important to the method's success for three reasons: 1. An organization doesn't need as many people in favorable OAs to convince someone who already supports them; 2. A majority of “unknown volunteers” are from these areas. By unknown volunteer, it is meant the man who talks to his neighbor while they are out mowing their lawns, however, he never officially volunteers, but sometimes, because of his sphere of influence, he reaches more voters than is realized; 3. The Optimum Level of Support (OLS) has already been reached and resources are needed to help push the Minimum Level of Support (MLS) in other areas. The user should attack everywhere, even in areas of most resistance. Forcing the opposing side to play defense often prevents them from playing offense. The user may choose to use a computer or database to store the “slots” that will become the comprehensive grassroots operational structure. Any means of creating a grassroots operational structure utilizing voter populations, favorability, or Minimum Staffing Levels is within the scope of the present invention.

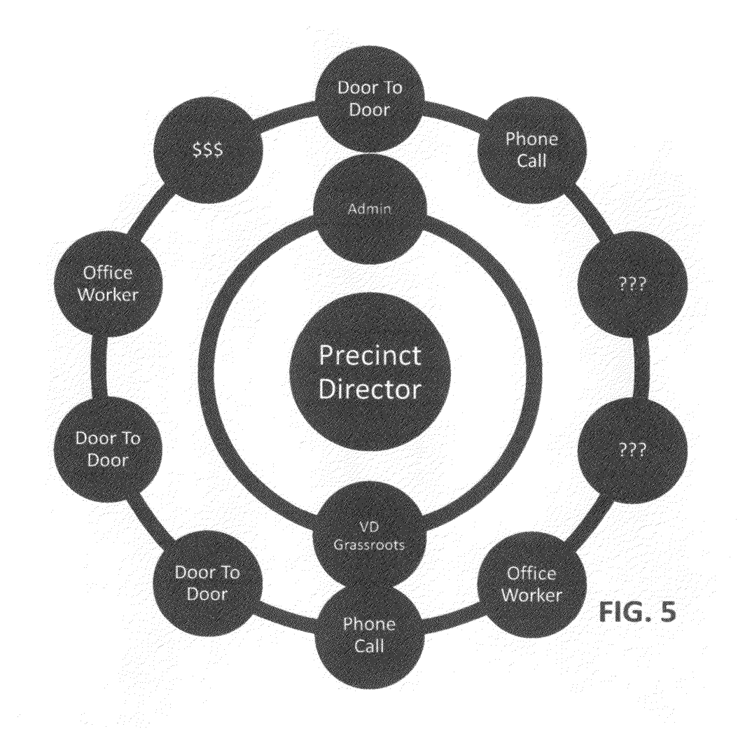

In the step of Filling 14, the user of the method will take the Minimum Staffing Levels established in the step of Assigning 12 and will fill those “Basic Operational Area” slots with actual positions to be utilized by leadership and volunteers. In this step, the user will only deal with the Basic OAs. When considering what positions to use to fill the Basic OA slots with, the user must consider the two types of positions: Primary and Secondary grassroots positions. Primary positions are that of phone caller (one who calls neighbors or voters); canvasser (one who goes door to door for the grassroots operation); fundraiser (one who raises money for the grassroots operation); director (one who leads the Basic OA); and admin (one who handles the administrative tasks for the Basic OA). Secondary positions are any additional job position necessary for the winning of that Basic OA, to include omni-slots which are able to accommodate any skill set within the Basic OA. By way of example but not limitation, there needs to be 10 volunteers to win a specific Basic OA. The user knows that they need a minimum of the primary positions; this leaves five slots to fill. The remaining five slots need to fit the Basic OA. The OA is a rural OA so the user opts for more phone calling positions (3) and two omni-slots (2). Each position has five pieces of information tied to that position: 1. How does this position fit into the organization's purpose; 2. What training is needed for this position; 3. Which other position does this position report to; 4. If applicable, the other positions that report to this position; and 5. The Position's Title. An example of the Basic OA module can be seen in FIG. 5.

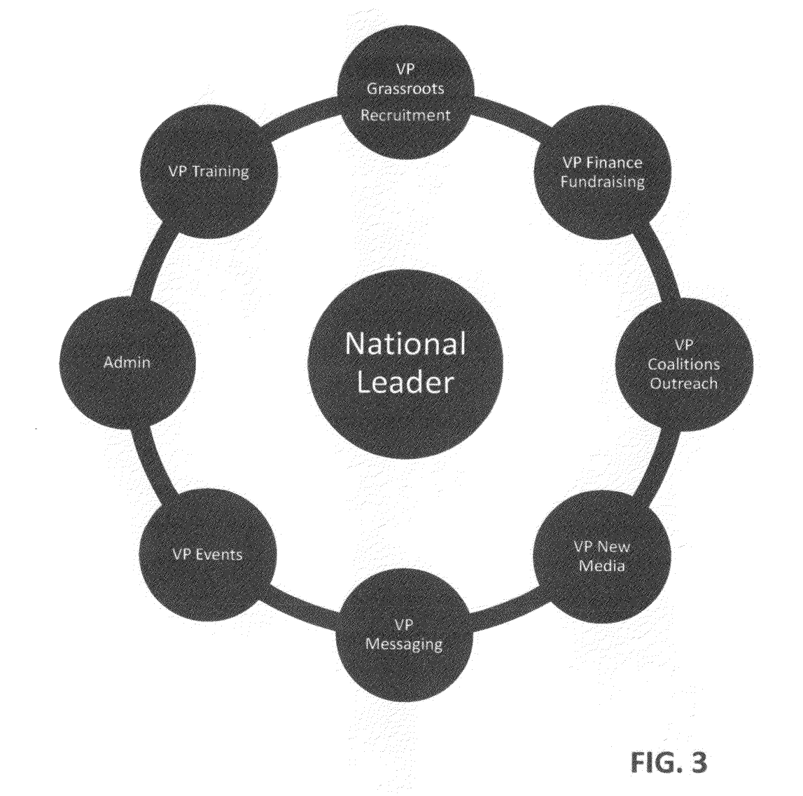

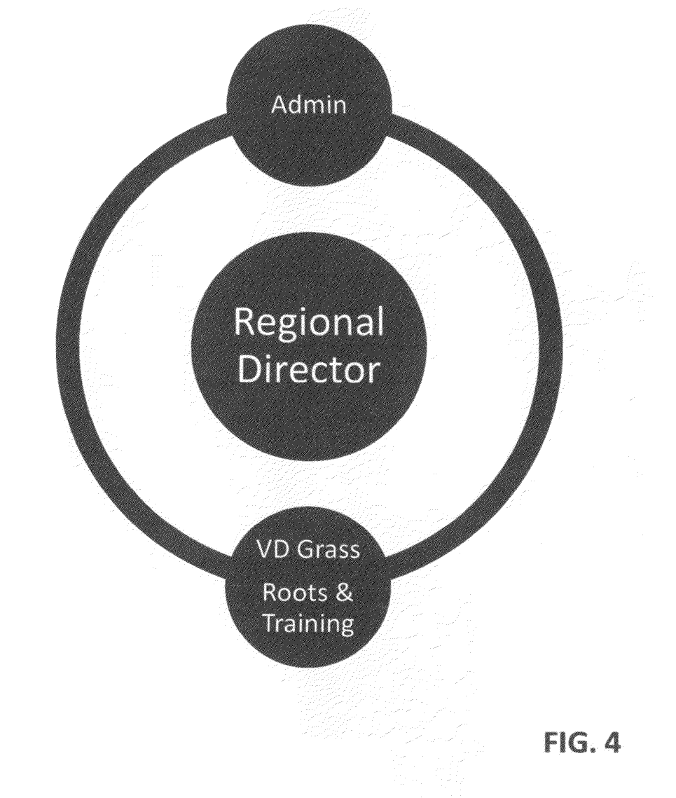

In the step of Developing 16, the user of the method will develop leadership modules for the Intermediary and Headquarters Operational Areas. The user must understand in developing the leadership modules that more favorable areas will have fewer volunteers to manage than unfavorable areas. The name(s) of the position(s) is simply a suggestion and a user may choose any other names or identities for these choices. As a rule, the intermediary Operational Areas will consist of: Director (Leader of the OA to include subordinate OAs); Assistant Director(s) (Assists the director, most of the time training to OA and subordinate OAs will be the function of the AD and depending on the size of the subordinate OAs there may be more than one); and Admin (handles the administrative functions for the OA to include maintaining the structure for subordinate OAs). The Headquarters OA will be more in depth, depending on the organizations needs. As a rule, the HQOA should include at a minimum: Director (Leader of the OA to include subordinate OAs); Admin (handles the administrative functions for the OA to include structure maintenance); Various Assistant Directors (In charge of everything from training, new media, message development, etc.); and Blogger (In charge of blogging and blogging direction for subordinate OAs). Each position has five pieces of information tied to that position: 1. How does this position fit into the organization's purpose; 2. What training is needed for this position; 3. Which other position does this position report to; 4. If applicable, the other positions that report to this position; and 5. The Position's Title. An example of the Intermediary and Headquarters OA modules can be found in FIGS. 3 and 4.

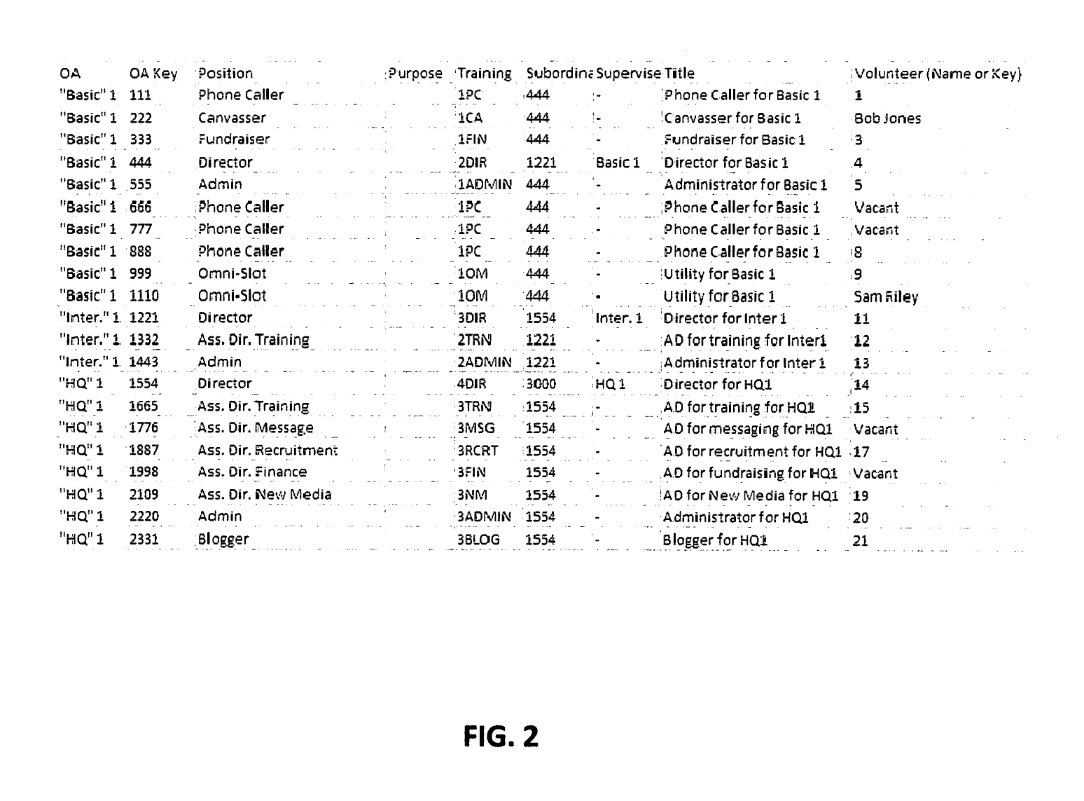

In the step of Completing 18, the user of the method completes the formation of the comprehensive grassroots operational structure. After the complete formation of the structure, said structure can be used for the additional steps in the method. A diagram of an example structure can be found in FIG. 2, the example is not meant to be limiting. If this step is performed by a user utilizing a computer or other machine, the structure may be recorded in any known information storage device, including RAM, magnetic media, or any other electronic medium. Any means of setting up a grassroots operational structure is within the scope of the present invention.

In the step of Managing 20, the user, along with delegated users of the structure, manage the entire structure with the tools that the structure allows from vacancy rates, needs analysis, skills analysis, favorability ratings, etc. The structure is easy to manage from a hierarchal point of view for the user. As a part of this step the following processes are utilized: 1. Reporting, the user utilizing the information needs to develop a plan of grassroots action integrated into the campaign or grassroots organization. This reporting is utilized at all levels of the Grassroots Operation, to strategize, recruit, place and manage the structure. Vacancy reports tell the user how many vacancies exist within the structure. By way of example but not limitation, in a specific Basic OA there are 10 positions, only 6 are occupied with volunteers, the leadership of that OA knows they have a 40% vacancy rate. Vacancy rates are also able to be reported on by position skill; 2. Recruiting, the user along with delegated users of the structure actively recruits against their vacancies to improve their vacancy rates and thus have more grassroots members where they are most needed. Because, the structure is already completed, understanding who and where to recruit is automatically effective and efficient. Volunteers self-identify skill sets upon volunteering to be used for the next process of Placing. If a recruit has not self-identified a skill set, their skills must be ascertained during this step; 3. Placing, the user along with delegated users of the structure place recruits into positions within the structure. A recruit (volunteer) is successfully placed within the structure within 24 hours of becoming a volunteer. The volunteer self-identifies their skill set for placement. By way of example but not limitation, Joe volunteers and says that he likes to make phone calls and that is all he likes to do. His skill is that of a phone caller and he needs placed in a phone caller position. Each position has five pieces of information tied to that position: 1. How does this position fit into the organization's purpose; 2. What training is needed for this position; 3. Which other position does this position report to; 4. If applicable, the other positions that report to this position; and 5. The Position's Title. Every member of the structure receives these five things at the time of placement. The names for the processes are simply suggestions; the user may choose any other names or identities for the processes within this step. The user may choose to utilize a separate electronic or non-electronic database for basic volunteer information (often referred to as a house list), the only identifier needed to “place” the volunteer in the structure is the volunteer name or other identifier of that volunteer (such as a database primary key). Management of the structure continues until the grassroots operations cease.

The preferred relationship among elements, including the preferred logic and chronological order is shown in the flow diagram, FIG. 3. The process preferably begins with the step of Incorporating 4 and ends in the step of Managing 20. As shown in the shown in the diagram, the step of Incorporating 4 preferably occurs before the step of Assessing 6, which preferably occurs before the step of Categorizing 8, and so forth. However, the order of many of these steps may be changed. The user must take care to finish the step of Completing 18 before the step of Managing 22. As another example but not limitation, the embodiment shown represents an embodiment that may be implemented by a computer and/or other machine. However, a human (e.g. grassroots coordinator) may not appear to execute the steps and decisions in the formal manner shown. For example, after the step of Categorizing 8, a human may make a decision to execute the steps along one of two different flow paths, each path corresponding to a preference indicated by the user. A first path, would be to follow the flow diagram as the computer and/or machine would. A second path, may include these steps, in order: Developing 16, Coding 10, Assigning 12, Filling 14, and then Completing 18. One of ordinary skill in the art will recognize that such a flow diagram (not shown) is equivalent to that shown in the drawing.

The method works as follows. When a user establishes a Grassroots Operational Plan utilizing basic operational values in the step of Incorporating 4, he sets values that will allow for the proper management of the grassroots operational structure and builds his grassroots operational structure along those lines. In the step of Assessing 6, he breaks the area he wants to organize into manageable Operational Areas. These Operational Areas are categorized in the step of Categorization 8. Once categorized, the user moves to the Basic Operational Areas (as categorized) and codes them in the step Coding 10, Assigns Minimum Staffing Levels to them in the step Assigning 12, and Fills them with positions that include: 1. How does this position fit into the organization's purpose; 2. What training is needed for this position; 3. Which other position does this position report to; 4. If applicable, the other positions that report to this position; and 5. The Position's Title, in the step Filling 14. Once that is complete he develops the leadership modules for the Intermediary and Headquarters Operational Areas in the step Developing 16. After that he completes the comprehensive grassroots operational structure in the step Completing 18. The user or the delegated users for the completed structure are able to manage the entire completed structure in the step Managing 20, this step is done through reporting, recruiting, and placing until the grassroots operation ends.

The step of Incorporating 4, may be omitted if the grassroots organization or campaign already has a Grassroots Operations Plan in place that satisfies the standards as outlined in the step of Incorporating, or have previously incorporated those values for a previous grassroots operation in which this method was used.

In one embodiment, the user is developing a grassroots operation in which there is NO Basic Operational Area. This may occur among grassroots operations that rely solely on online efforts where going down to the lower organizational levels is seen as ineffective, in which case steps 10, 12, and 14 may be omitted. However, once online efforts go live, Basic Operational Areas will be created and steps 10, 12, and 14 will be completed at a later time.

In another embodiment, the user may choose to use different operational terms that fit better with the organization or cultural area being organized. By way of example and not limitation, the user may choose to not use “Basic,” “Intermediary,” or “Headquarters.” Instead they opt for “Primary,” “Intermediary,” and “Expert.” One of ordinary skill in the art will recognize that such semantic steps are required but that the user is still using the present method.

A software program could be designed to implement this method for various grassroots organizations. The software may receive input from the user and then automatically produce the comprehensive grassroots operational structure.

A program could be developed to allow delegated users to manage their portions of the structure from an input device or from the internet.

In a different field, corporations may utilize this method to organize loyal consumers to change perceptions about a brand on the ground, in the community, near brick and mortar stores and online.

A user of ordinary skill in the art would understand how to use this invention based on the description thus far.

The invention could be used by corporations to organize loyal consumers to change perceptions about a brand on the ground, in the community, near brick and mortar stores and online.

The invention could be used by non-profits or religious groups to organize movements for conversion of the general public to their belief or cause.

Social networks, grassroots organizations, fraternal organizations, and political campaigns

The method will produce operational success through greater efficiency in grassroots operations. The method also produces better outcomes for corporations or other organizations who wish to meet consumers in an organized personal way cheaper than a traditional advertising campaign. The method drastically improves the efficiency of recruitment, training, and retention in organizations.

What is claimed is:

1. A method for organizing grassroots (individuals or collective groups of people) operations to a user's preference utilizing a comprehensive grassroots operational structure, producing operational success through greater efficiency in grassroots operations, recruitment, training, and retention within the organization comprising the steps of
incorporating a Grassroots Operational Plan utilizing basic operational values that will allow for the proper management of the grassroots operational structure and building a grassroots operational structure along those lines;
assessing the area to be organized and breaking the area to be organized into manageable Operational Areas;
categorizing the Operational Areas into categories wherein the categories speak to the functionality of the Operational Area, typically three categories are used, “basic”, “intermediary”, and “headquarters”;
coding the “basic” Operational Areas wherein the coding is based on favorability of the Operational Area;
assigning Minimum Staffing Levels (MSL) to the “Basic” Operational Areas, based on the coding of the Operational Areas;
filling the MSL slots in the “Basic” Operational Areas with positions wherein the position is a grassroots function.
developing the leadership modules for the “Intermediary” and “Headquarters” Operational Areas wherein the leadership modules utilize the needs of the organization as prescribed by the grassroots operations plan;
completing the comprehensive grassroots operational structure for use; and
managing the entire completed comprehensive grassroots operational structure wherein the structure is managed through reporting, recruiting, and placing until the grassroots operation ends.

2. The method of claim 1, wherein the step of filling the MSL slots in the “Basic” Operational Areas with positions consisting of 1. How does this position fit into the organization's purpose; 2. What training is needed for this position; 3. Which other position does this position report to; 4. If applicable, the other positions that report to this position; and 5. The Position's Title.

3. The method of claim 1, wherein the step of incorporating a Grassroots Operational Plan utilizing basic operational values consisting of 1. Purpose (How does the grassroots perpetuate the mission of the organization?); 2. Leadership (Who manages the structure and how are their roles used to manage the grassroots operational structure?); 3. Volunteers (The backbone of the grassroots operation, how are they utilized what volunteer skills are needed?); 4. Training (Quick and thorough training is necessary for effective organisation, how is this training incorporated); 5. Standards (What goals and metrics for success are in place to ensure the Grassroots Operation works to its fullest potential?); and 6. Continuity (What is the plan to continue the grassroots operation even after volunteers have left or come into the structure?).

4. The method of claim 1, wherein the step of coding the “Basic” Operational Areas wherein the coding consists of Green (Over 55% of the population in this GO holds a favorable view of the purpose of the grassroots organization); Yellow (48-55% favorable); or Red (below 48% favorable).

5. The method of claim 1, wherein the step of assigning Minimum Staffing Levels (MSL) to the “Basic” Operational Areas, based on the coding of the Operational Areas consists of, if the Operational Area is coded Green (1 volunteer for every 100 voters); OA is coded Yellow (1 volunteer for every 75 voters); OA is coded Red (1 volunteer for every 50 voters); and the minimum MSL for any given Operational Area is 5.

6. The method of claim 1, wherein the step of developing the leadership modules for the “Intermediary” and “Headquarters” Operational Areas consists of each position within the modules having five pieces of information tied to those positions: 1. How does this position fit into the organization's purpose; 2. What training is needed for this position; 3. Which other position does this position report to; 4. If applicable, the other positions that report to this position; and 5. The Position's Title.

7. The method of claim 1, wherein the user may choose to use different operational terms that fit better with the organization or cultural area being organized. By way of example and not limitation, the user may choose to not use “Basic,” “Intermediary,” or “Headquarters.” Instead they opt for “Primary,” “Intermediary,” and “Expert.” One of ordinary skill in the art will recognize that such semantic steps are required but that the user is still using the present method.

8. The method of claim 1, wherein the step of managing the structure through reporting, reporting consisting of the user, utilizing the information, develops a plan of grassroots action integrated into the campaign or grassroots organization. This reporting is utilized at all levels of the Grassroots Operation, to strategize, recruit, place and manage the structure. Vacancy reports tell the user how many vacancies exist within the structure. Vacancy rates are also able to be reported on by position skill.

9. The method of claim 1, wherein the step of managing the structure through recruiting, recruiting consisting of the user along with delegated users of the structure actively recruiting against their vacancies to improve their vacancy rates and thus have more grassroots members where they are needed. Volunteers self-identify skill sets upon volunteering to be used for the next process of Placing. If a recruit has not self-identified a skill set, their skills must be ascertained during this step.

10. The method of claim 1, wherein the step of managing the structure through placing, placing consisting of the user along with delegated users of the structure placing recruits into positions within the structure. A recruit (volunteer) is successfully placed within the structure within 24 hours of becoming a volunteer. The volunteer self-identifies their skill set for placement. Each position has five pieces of information tied to that position: 1. how does this position fit into the organization's purpose; 2. what training is needed for this position; 3. which other position does this position report to; 4. if applicable, the other positions that report to this position; and 5. The Position's Title. Every member of the structure receives these five things at the time of placement.

11. The method of claim 1, wherein the step of managing the structure, consists of the user choosing to utilize a separate electronic or non-electronic database for basic volunteer information (often referred to as a house list), the only identifier needed to “place” the volunteer in the structure is the volunteer name or other identifier of that volunteer (such as a database primary key).
